(19) United States
(12) Patent Application Publication
(10) Pub. No.: US 2021/0036623 A1
(43) Pub. Date: Feb. 4, 2021

(54) TWO-STAGE STEP-DOWN CONVERTER

(71) Applicant: HEWLETT PACKARD ENTERPRISE DEVELOPMENT LP, Houston, TX (US)

(72) Inventors: Mohamed Amin Bemat, Cypress, TX (US); Ali Salem Ba-Thunya, Houston, TX (US)

(21) Appl. No.: 16/525,951

(22) Filed: Jul. 30, 2019

(51) Int. Cl. H02M 3/335; G05B 15/02; G06F 1/26

(52) U.S. Cl. CPC H02M 3/33576; G06F 1/26; G05B 15/02

(57) ABSTRACT

A two-stage step-down converter includes a first stage and a second stage operatively connected to the first stage. The first stage is to step down an input voltage to an intermediate periodic signal and includes a primary side, a secondary side, and a plurality of transformers to electromagnetically couple the primary side and the secondary side to step down the input voltage to the intermediate periodic signal. The primary windings of the transformers are connected in series and the secondary windings are connected in parallel.

### BACKGROUND

Many computing devices use voltage regulators to “convert” an input voltage signal that is unusable to its components to a voltage signal that is satisfactory for use. This sometimes involves “stepping down” the input voltage to another, lower voltage. The step down is usually implemented in two stages and uses a transformer in one or both stages. Such circuits are known as two-stage step-down converters.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates selected portions of a computing device including a power supply employing a two-stage step-down converter in accordance with one or more examples.

FIG. 2 is a block diagram of a first stage of the two-stage step-down converter of FIG. 1 according to examples disclosed herein.

FIG. 3A depicts a multi-phase switching buck regulator such as may be used to implement the second stage of the two-stage step-down converter of FIG. 1 in some examples.

FIG. 3B depicts a low pass filter such as may be used to implement the second stage 125 of the two-stage step-down converter of FIG. 1 in some examples.

FIG. 4 depicts one particular example of a switch controller as may be used in some examples of the two-stage step-down converter of FIG. 1.

FIG. 5 depicts one particular first stage that is one example of the first stage first shown in FIG. 1.

FIG. 6 depicts simulated results for the operation of the first stage of FIG. 5.

FIG. 7 depicts one particular first stage that is one example of the first stage first shown in FIG. 1.

FIG. 8 depicts simulated results for the operation of the first stage of FIG. 7.

FIG. 9 depicts one particular first stage that is one example of the first stage first shown in FIG. 1.

FIG. 10 depicts simulated results for the operation of the first stage of FIG. 9.

FIG. 11 depicts one particular first stage that is one example of the first stage first shown in FIG. 1.

FIG. 12 depicts simulated results for the operation of the first stage of FIG. 5.

FIG. 13 conceptually illustrates selected portions of a computing device including a power supply employing a two-stage step-down converter in accordance with one or more examples.

FIG. 14 illustrates a method for use in powering an electronic component in a computing device, such as the electrical load of the computing device shown in FIG. 1.

While the invention is susceptible to various modifications and alternative forms, the drawings illustrate specific examples herein described in detail by way of example. It should be understood, however, that the description herein of specific examples is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Two-stage step-down converters typically use two stages to perform conversion. In one example, the first stage converts a 48V signal to a 12V DC signal using custom built multi-turn step down transformer and the second stage uses a multi-phase switching buck regulator as a voltage regulator-down (“VRD”). In some instances, transformers present a number of challenges in that they are large, heavy, and occupy considerable space. Transformer construction utilizing planar windings to achieve small size present further challenges to system PCA layout like using PCB with more copper layers and magnetic core adjustments in such transformer construction increase manufacturing challenges.

This disclosure presents a topology that, through its construction and operation, addresses challenges found in two-stage step-down converters used in computing devices. The disclosed topology converts an input signal (e.g., 48V signal) to operating levels (1.8V, 1.2V, 1.0V, etc.) that may then be used by electrical loads found in computing devices. Examples of such electrical loads include, without limitation, processing resources (e.g., central processing units, or “CPUs”), memory resources (e.g., dual in-line memory modules, or “DIMMs”), and other application specific integrated circuits (“ASICs”). This list of electrical loads is neither exhaustive nor exclusive.

The disclosed topology, in at least one example, employs a plurality of smaller transformers to perform the step-down rather than a single larger transformer with a switching control scheme. Accordingly, disclosed examples may provide for high efficiency, fast response to transient loads, high density, and present a low cost solution. In summary, instead of a single large transformer with an K:1 turns ratio to step-down an input voltage Vᵢₙ to an intermediate voltage equal to Vᵢₙ/K, the presently disclosed topology may employ K simpler, smaller, transformers, each having a 1:1 turns ratio, with the primary windings of the K transformers being connected in series and the secondary windings being connected in parallel. More specifically, in an example, instead of a single transformer with a 4:1 turns ratio to step-down from 48V to 12V, the presently disclosed topology may employ four simpler, smaller, transformer, each having a 1:1 turns ratio. The primary windings of the four transformers, in this example, are connected in series and the secondary windings are connected in parallel.

These 1:1 turns ratio transformers are smaller, simpler, and can meet small inductor footprints similar to the parts used in 12V input multi-phase converters. Thus, they may have an approximate size of 10 mm (W)×10 mm (L)×10 mm (H)). To minimize the size of these transformers, some examples use a 1 MHZ or higher switching frequency when in operation. In general, “high speed switching” as used herein means high frequency switching, typically 500 KHz and above. To increase conversion efficiency, some examples generate square wave pulses with 12V amplitude and a 10% to 90% duty cycle at the output of a synchronous switch rectifier of the 48V to 12V converter.

The first stage outputs an “intermediate signal” to the second stage. This intermediate signal is the “stepped down” signal—e.g., a square wave signal stepped down from 48V to 12V with a 10% to 90% duty cycle. The second stage may be a high efficiency, multi-phase buck converter although some examples may instead be, for instance, a low pass filter.

In one example, a multi-phase buck converter is designed with multiple buck converter stages connected to single input source of the intermediate periodic signal. Each buck converter is sized to deliver Iₘₐₓ/n load current where Iₘₐₓ is the peak output current and n is the number of phases. The second stage buck converter delivers a low voltage, high current, high transient DC output. The second stage multi-phase buck converter voltage regulation may be achieved by various control architectures like Pulse Width Modulation (Fixed Frequency), Fixed On Time Control (Variable frequency), etc. In examples using an input square wave pulse train to the multi-phase converter, the square wave pulse train enables each phase high side switching FET (buck FET) to be controlled to switch on/off during minimum voltage across the device (0V) achieving zero voltage switching (“ZVS”) loss.

Therefore, according to some examples, a two-stage step-down converter includes a first stage and a second stage operatively connected to the first stage. The first stage is to step down an input voltage down to an intermediate periodic signal and includes a primary side, a secondary side, and a plurality of transformers to electromagnetically couple the primary side and the secondary side to step down the input voltage to the intermediate periodic signal. The primary windings of the transformers are connected in series and the secondary windings are connected in parallel.

In other examples, a method for use in powering an electronic component in a computing device includes: receiving an input voltage; conditioning the input voltage; stepping down the conditioned input voltage to an intermediate periodic signal using a plurality of transformers electromagnetically coupling a primary side of a first stage of a two-stage step-down converter and a secondary side of the first stage of the two-stage step-down converter, the primary windings of the transformers being connected in series and the secondary windings being connected in parallel; and outputting the intermediate periodic signal to a second stage of the two-stage step-down converter.

In still other examples, a computing device includes: a two-stage step-down converter to convert an input voltage to an output voltage less than the input voltage, the two-stage step-down converter including a plurality of transformers electromagnetically coupling a primary side of a first stage of the two-stage step-down converter and a secondary side of the two-stage step-down converter to step down the input voltage to an intermediate periodic signal, the primary windings of the transformers being connected in series and the secondary windings being connected in parallel; a switch controller to control a first plurality of switches in the primary side and a second plurality of switches in the secondary side; and an electrical load to consume an output signal of the two-stage step-down converter at the output voltage.

Illustrative examples of the subject matter claimed below will now be disclosed. In the interest of clarity, not all features of an actual implementation are described for every example in this specification. It will be appreciated that in the development of any such actual example, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The present disclosure presents a technique including a new topology to convert one voltage (e.g., 48V) down to a second voltage (e.g., 2.5V or lower). This second voltage is a suitable operating voltage level for a central processing unit (“CPU”) and/or a double data rate (“DDR”) memory module (e.g., dual in-line memory module (“DIMM”)), or an ASIC, for instance. The disclosed technique may be used, for example, to replace custom built, multi-turn step down transformers (e.g., 48V to 12V conversion) with multiple small size, industry standard, simple construction (e.g., 1:1 turns ratio) transformers. The primary windings of the multiple transformers are connected in series and the secondary windings in parallel on the host printed circuit board (“PCB”).

In some examples, a square wave pulse of 50% duty cycle and 12V amplitude is generated as output of a 48V to 12V converter stage using these transformers. This output is then converted to low voltage, high current, high transient DC output by a multi-phase buck converter. Design optimization of different topology configurations and use of high frequency for conversion (1 MHz or higher) permits high density. The total number of devices supported may be increased by up to ˜33% compared to typical 12V converter solutions. Approximating the equivalent size and cost of the solution to a 12V input multi-phase solution, the 48V input solution is 16 phase versus a 12 phase solution to power a CPU and twelve times as many DDR memory modules.

More particularly, in examples disclosed herein, the two-stage step-down converter is a two-stage design. The first stage drops the voltage from 48V to 12V amplitude pulse with 50% duty cycle and average voltage of 6V. One goal is to minimize the space on the board and a second goal is to reduce the cost by eliminating input filter(s) otherwise used for the second stage. The two-stage step-down converter has a high switching frequency to minimize the transformer size. In one example, the second stage consists of a multi-phase switching buck converter to minimize or eliminate the switching losses, thereby improving efficiency while providing a high-density solution. In another example, the second stage is a low pass filter.

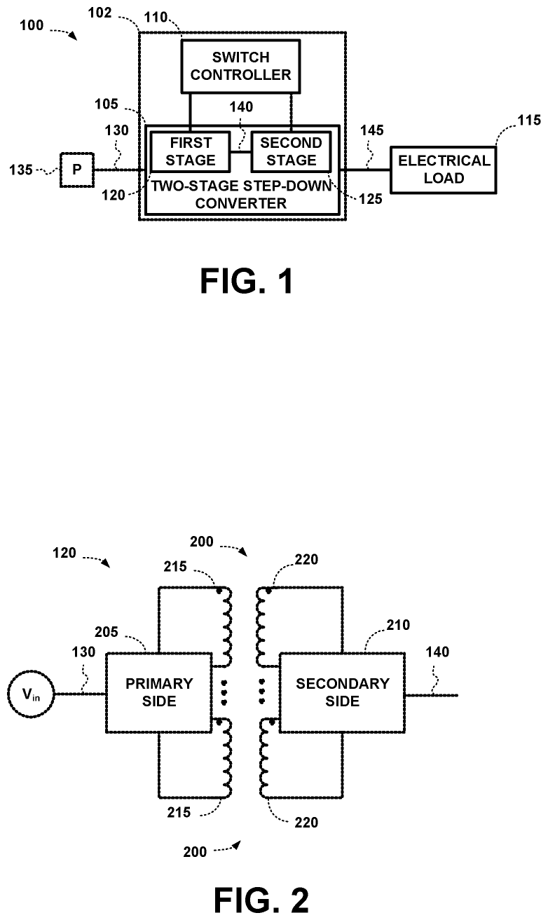

Turning now to the drawings, FIG. 1 conceptually illustrates selected portions of a computing device 100 employing a power supply 102 including a two-stage step-down converter 105 in accordance with one or more examples. In addition to the two-stage step-down converter 105, the power supply 102 includes a switch controller 110. The computing device 100 includes an electrical load 115. In most examples, the computing device 100 will include many electrical loads 115 but only a single electrical load 115 is shown in FIG. 1 for the sake of clarity and so as not to obscure that which is claimed below. The electrical load 115 may be, for instance, a CPU, a memory device such as a double data rate (“DDR”) memory module (e.g., dual in-line memory module (“DIMM”)), or an ASIC. These examples are neither exclusive nor exhaustive and other kinds of electrical loads 115 may be powered using the two-stage step-down converter 105.

Each of the first stage 120 and the second stage 125 includes a plurality of switches (not shown in FIG. 1). The switch controller 110 controls the switches of the first stage 120 and the second stage 125 (when switches are present) of the two-stage step-down converter 105 in a manner discussed more fully below. In some examples, the switch controller 110 may be considered a part of the two-stage step-down converter 105 while in others it may be considered separate.

In FIG. 2, one example of the first stage 120 is shown. This example includes two transformers 200, but other examples may use other numbers of transformers 200 where the number is greater that one. The transformers 200 electromagnetically couple a primary side 205 and a secondary side 210 of the first stage 120. Although not shown in FIG. 2, the primary windings 215 of the transformers are connected in series and the secondary windings 220 are connected in parallel. Additional examples where this is illustrated are provided below.

As will be discussed below, both the primary side 205 and the secondary side 210 include a plurality of switches whose operation is controlled by the switch controller 110. In the primary side 205, the switches are used to control the voltage impressed across transformer primary at a predetermined switching frequency (e.g., 1 MHz) and predetermined duty cycle (e.g., 50%, meaning 50% ON, 50% OFF in a switching cycle). These control parameters determine the rate of energy transfer from primary side 205 to secondary side 210 and size of magnetic components in the circuit. The switches in the secondary side 210 deliver, in the examples illustrated herein, a square wave output to the second stage 125. The switches of the secondary side 210 are controlled in accordance with control of the switches in the primary side 205 to achieve this function.

The size of the transformers 200 may be selected based on the switching frequency of the switches in the first stage 120. Higher switching frequencies permit the use of smaller transformers 200. In one example, the transformers 200 each occupy a footprint no larger than 10 mm wide×10 mm long and is no taller than 10 mm high. The transformers 200 are 1:1 turns ratio transformers. The number of transformers 200 is, in the illustrated examples, in proportion to the step-down of the voltage of the input signal 130. In various examples illustrated below, the voltage of the input signal is 48V and the first stage 105 uses four transformers 200 to step down the voltage of the intermediate signal 140 to 12V. However, other examples may step down the input voltage differently and use different numbers of transformers 200.

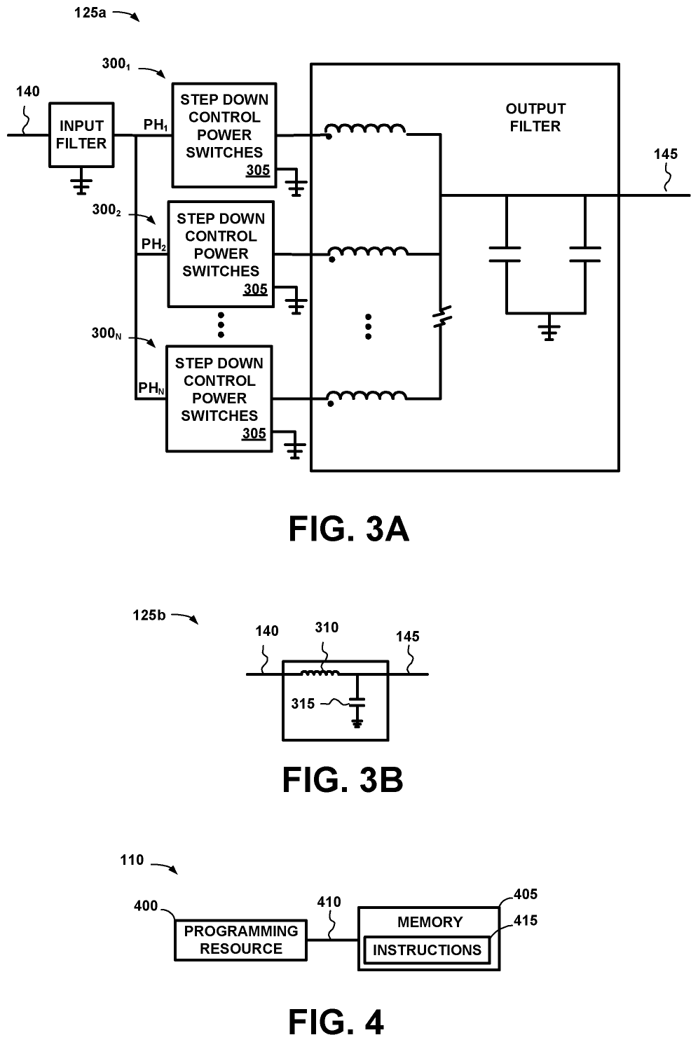

Returning to FIG. 1, the second stage 125 of the illustrated examples may be a switching multi-phase buck converter. The switching multi-phase buck converter may be of conventional design, such as the designs shown in FIG. 3A. The second stage 125 actually includes N buck converters 300₁-300_{N}, where N is the number of phases. As previously discussed, each buck converter 300₁-300_{N} is sized to deliver Iₘₐₓ/N load current where Iₘₐₓ is the peak output current and N is, again, the number of phases. The second stage buck converter delivers a low voltage, high current, high transient DC output. The second stage 125 multi-phase buck converter voltage regulation may be achieved by various control architectures like Pulse Width Modulation (Fixed Frequency), Fixed On Time Control (Variable frequency), etc. In examples using an input square wave pulse train to the multi-phase converter, the square wave pulse train enables each phase high side switching FET (buck FET) to be controlled to switch on/off during minimum voltage across the device (0V) achieving zero voltage switching (“ZVS”) loss.

Note that the second stage 125a of FIG. 3A includes a plurality of switches 305 that are controlled by the switch controller 110 of FIG. 1. The second stage 125a conditions the intermediate periodic signal 140 and then outputs a signal 145 with the stepped down voltage to the electrical load 115. The signal 145 is a low voltage, high current, high transient DC output voltage suitable for powering electrical loads 115 commonly found within a computing device.

Returning to FIG. 1 again, in other examples, the second stage 125 may be a low pass filter of conventional design such as the one presented in FIG. 3B. The low pass filter includes an inductor 310 receiving the intermediate periodic signal 140 directly from the transformers 200, shown in FIG. 2, of the first stage 205. Note that this second stage 125b contains no switches for the switch controller 110 to control. The low pass filter of the second stage 125b produces an average voltage that has been stepped down and may be used to power electrical loads as described herein.

The switch controller 110 may be implemented as a control circuit (not otherwise shown) or a programmed processing resource. A control circuit may be implemented in, for instance, a programmed Electrically Erasable Programmable Read-Only Memory (“EEPROM”), an Application Specific Integrated Circuit (“ASIC”), or an electronic circuit. One particular example of the switch controller 110 is depicted in FIG. 4. In this example, the switch controller 110 includes a processing resource 400, which may be a microcontroller. The processing resource is programmed from the memory 405 over a bus 410 of some kind. A plurality of instructions 415 reside on the memory 405. On power up or reset, the processing resources 400 loads the instructions 415 from the memory 405 and begins executing the instructions 415 to control the switches of the two-stage step-down converter 105. Note that other examples may implement the switch controller 110 differently.

In operation, the two-stage step-down converter 105 receives an input signal 130 having an input voltage from a power source 135. The first stage 120 of the two-stage step-down converter 105 conditions the input signal 130 and its input voltage Vᵢₙ. The input voltage Vᵢₙ may be, for instance, 48V in some examples. In general, the two-stage step-down converter 105 steps down the conditioned input voltage Vᵢₙ to an intermediate periodic signal 140 using a plurality of transformers 200, shown in FIG. 2, in the primary side 120. In the illustrated examples, the intermediate periodic signal 140 is square wave signal. In some examples, the intermediate periodic signal 140 may be a 12V signal with a 90% duty cycle, in others a 24V signal with a 90% duty cycle, while in others it may be a 12V signal with a 50% duty cycle. In general, the square wave intermediate signal may be stepped down from 48V to 12V with a 10% to 90% duty cycle.

The secondary side 210 of the first stage 120 and the second stage 125 act as a synchronous switch rectifier. Synchronous switching is a typical rectifier function of unidirectional current flow with typical diode forward conduction characteristics. However, the synchronous switching uses Metal Oxide Semiconducting Field Effect (“MOSFET”) devices to significantly reduce forward voltage drop hence power loss in each rectifier device. The gates of the MOSFET devises should controlled to achieve the unidirectional current flow function which is called synchronous rectifier control. The MOSFET device is called synchronous rectifier. The second stage 125 then conditions through rectification the intermediate signal 140 to produce a regulated DC output signal 145 having a low voltage.

In this context, a “low” voltage as used herein means a direct current (“DC”) voltage of less than 2.5V. The low voltages described herein are also “low” in the sense that are suitable for powering the electrical loads 115 of the computing device 100. Thus, examples of a “low” voltage within the context of the present disclosure include 1.8V, 1.2V, and 1.0V. These examples are neither exclusive nor exhaustive, as a low voltage may be any voltage lower than 2.5V DC.

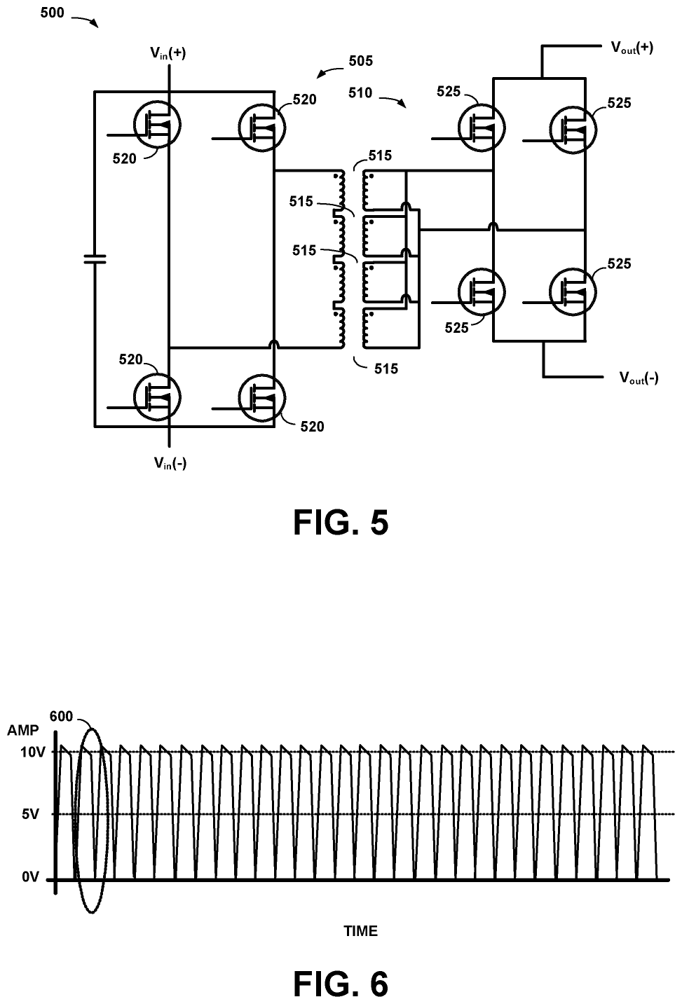

FIG. 5 depicts one particular first stage 500 that is one example of the first stage 120. The first stage 500 is a full bridge topology that accepts a 48V input and generates a 12V, square wave output with an up to 90% duty cycle pulse. The first stage 500 includes a primary side 505 and a secondary side 510 electromagnetically connected by four transformers 515. Note that this first stage 500 steps down the input voltage by a factor of four and that there are four transformers 515. The primary side 505 includes four switches 520 implemented using MOSFET devices and controlled by the switch controller 110, shown in FIG. 1. The secondary side 510 also includes four switches 525 also implemented using MOSFET devices and controlled by the switch controller 110.

FIG. 6 depicts simulated results for the operation of the first stage 500. The simulated results are illustrated in a graph of voltage over time for a plurality of switch cycles 600. Note the square shape and duty cycle of the signal. The amplitude of the signal varies between 0 and 12V and the duty cycle is 90%. The switch cycle is 500 KHz, although the switch cycle for this particular topography may be as much as 1 MHz or greater.

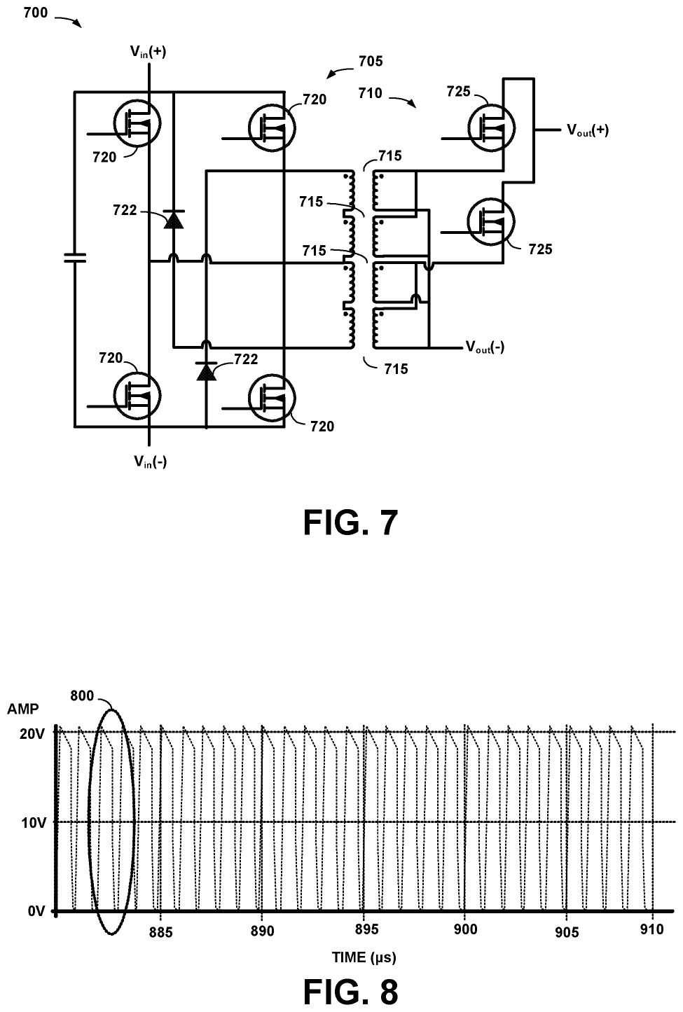

FIG. 7 depicts one particular first stage 700 that is one example of the first stage 120. The first stage 700 is a topology with two forward converters sharing the same magnetic circuit with two diodes reduction. The first stage 700 accepts a 48V input and generates a 24V, square wave output with an up to 90% duty cycle pulse. The first stage 700 includes a primary side 705 and a secondary side 710 electromagnetically connected by four transformers 715. Note that this first stage 700 steps down the input voltage by a factor of two and that there are four transformers 715. The primary side 705 includes four switches 720 implemented using MOSFET devices and controlled by the switch controller 110, shown in FIG. 1. The primary side 705 also includes two diodes 722. The secondary side 710 includes two switches 725 also implemented using MOSFET devices and controlled by the switch controller 110.

FIG. 8 depicts simulated results for the operation of the first stage 700. The simulated results are illustrated in a graph of voltage over time for a plurality of switch cycles 800. Note the square shape and duty cycle of the signal. The amplitude of the signal varies between 0 and 24V and the duty cycle is 90%. The switch cycle is 500 KHz, although the switch cycle for this particular topography may be as much as 1 MHz or greater.

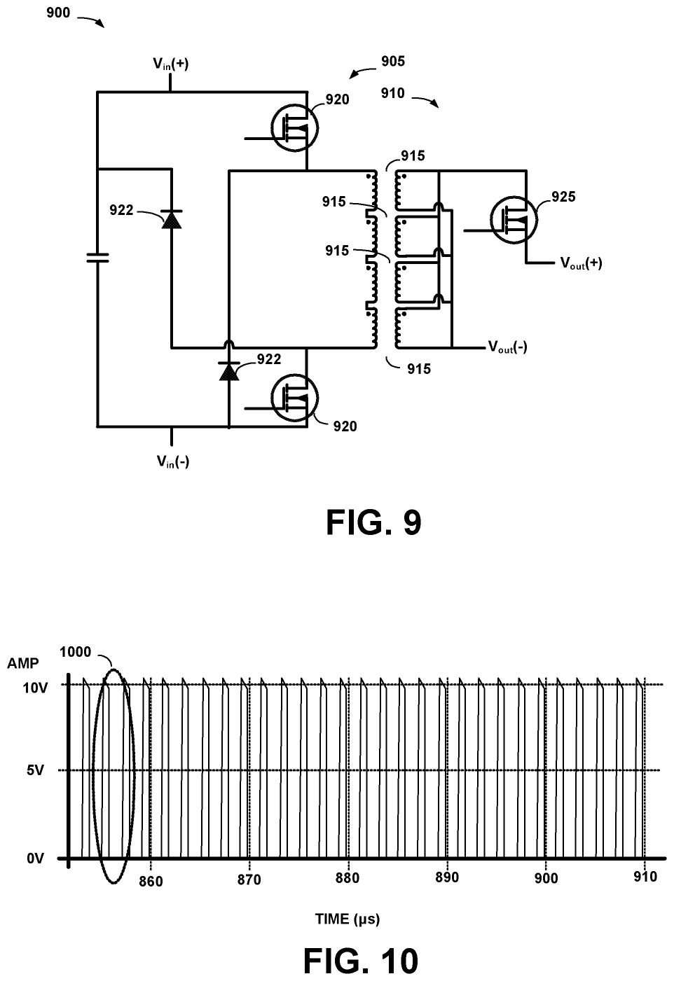

FIG. 9 depicts one particular first stage 900 that is one example of the first stage 120. The first stage 900 is a forward converter topology. The first stage 900 accepts a 48V input and generates a 12V, square wave output with an up to 50% duty cycle pulse. The first stage 900 includes a primary side 905 and a secondary side 910 electromagnetically connected by four transformers 915. Note that first stage 900 steps down the input voltage by a factor of four and that there are four transformers 915. The primary side 905 includes two switches 920 implemented using MOSFET devices and controlled by the switch controller 110, shown in FIG. 1. The primary side 905 also includes two diodes 922. The secondary side 910 includes a single switch 925 also implemented using MOSFET devices and controlled by the switch controller 110.

FIG. 10 depicts simulated results for the operation of the first stage 900. The simulated results are illustrated in a graph of voltage over time for a plurality of switch cycles 1000. Note the square shape and duty cycle of the signal. The amplitude of the signal varies between 0 and 12V and the duty cycle is 50%. The switch cycle is 500 KHz, although the switch cycle for this particular topography may be as much as 1 MHz or greater.

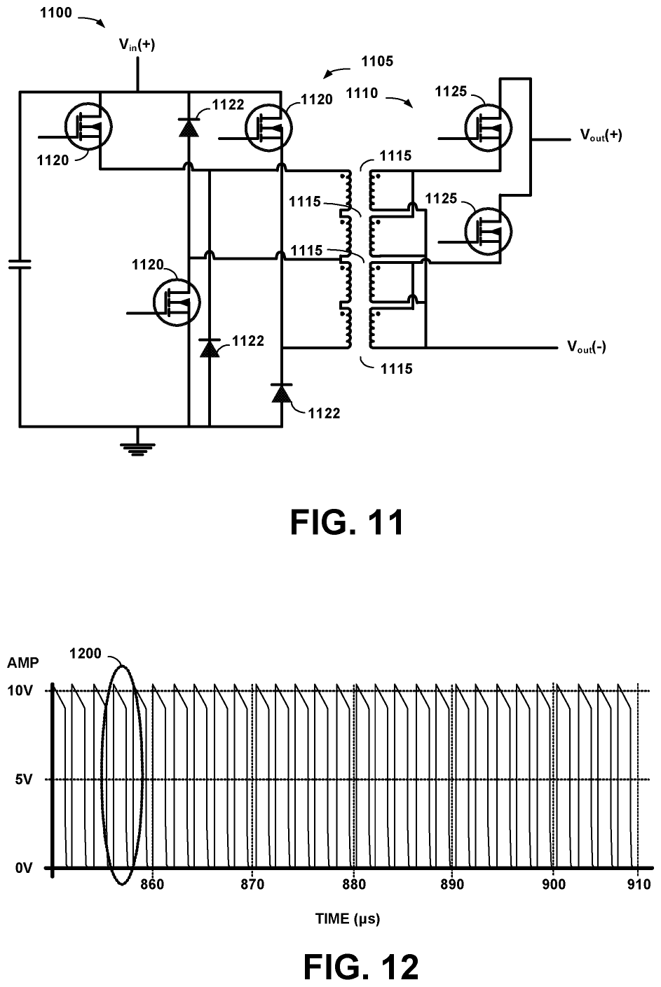

FIG. 11 depicts one particular first stage 1100 that is one example of the first stage 120. The first stage 1100 is a topology including two forward converter sharing the same magnetic circuit with one switch and one diode reduction. The first stage 1100 accepts a 48V input and generates a 24V, square wave output with an up to 90% duty cycle pulse. The first stage 1100 includes a primary side 1105 and a secondary side 1110 electromagnetically connected by four transformers 1115. Note that this first stage 1100 steps down the input voltage by a factor of two and that there are four transformers 1115. The primary side 1105 includes three switches 1120 implemented using MOSFET devices and controlled by the switch controller 110, shown in FIG. 1. The primary side 1105 also includes three diodes 1122. The secondary side 1110 includes two switches 1125 also implemented using MOSFET devices and controlled by the switch controller 110.

FIG. 12 depicts simulated results for the operation of the first stage 1100. The simulated results are illustrated in a graph of voltage over time for a plurality of switch cycles 1200. Note the square shape and duty cycle of the signal. The amplitude of the signal varies between 0 and 24V and the duty cycle is 90%. The switch cycle is 500 KHz, although the switch cycle for this particular topography may be as much as 1 MHz or greater.

Those in the art having the benefit of this disclosure may appreciate implementation for the first stage and the second stage alternative to those presented above. Similarly, those in the art having the benefit of this disclosure may realize still other examples in which the two-stage step-down converter disclose herein may be used.

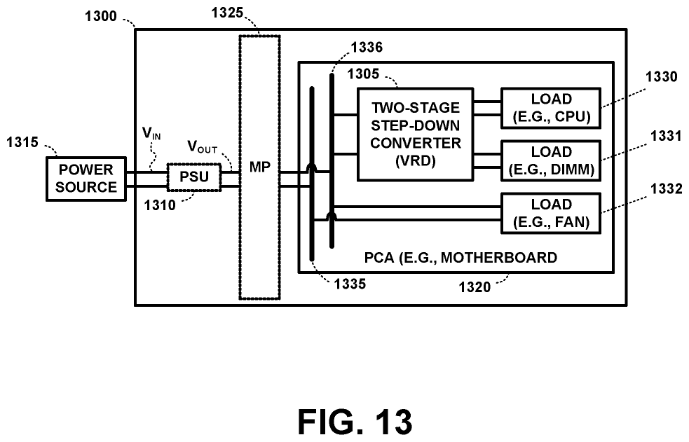

FIG. 13 conceptually illustrates selected portions of a computing device 1300 including a power supply employing a two-stage step-down converter 1305 in accordance with one or more examples. The computing device 1300 includes a power supply unit (“PSU”) 1310. The PSU 1310 receives a power signal V_{IN} from an external power source 1315. The external power source 1315 may be an electrical grid or an electrical generator, for instance. The PSU 1310 outputs a power signal V_{OUT} to a printed circuit assembly (“PCA”) 1320 through an optional midplane (“MP”) 1325. The PCA 1320 may be, in some examples, a motherboard.

The PCA 1320 is populated with a number of electrical loads 1330-1332. Voltage is distributed throughout the PCA 1320 and to the electrical loads 1330-1332 through a pair of power rails 1335, 1336. The voltage available from the power rails 1335, 1336 is the voltage output by the PSU 1310 and may be, for instance, 48V. Although 48V may be suitable for the electrical load 1332 (e.g., a fan), it is not suitable for the electrical loads 1330-1331 (e.g., a CPU and a DIMM). The electrical loads 1330, 1331 operate off much lower voltages, for instance, 1.2V. The two-stage step-down converter 1305 is therefore used to step down the voltage available from the power rail 1336 down to a voltage suitable for powering the electrical loads 1330, 1331. The two-stage step-down converter 1305 in this example is designed and operates in the manner of the examples disclosed above.

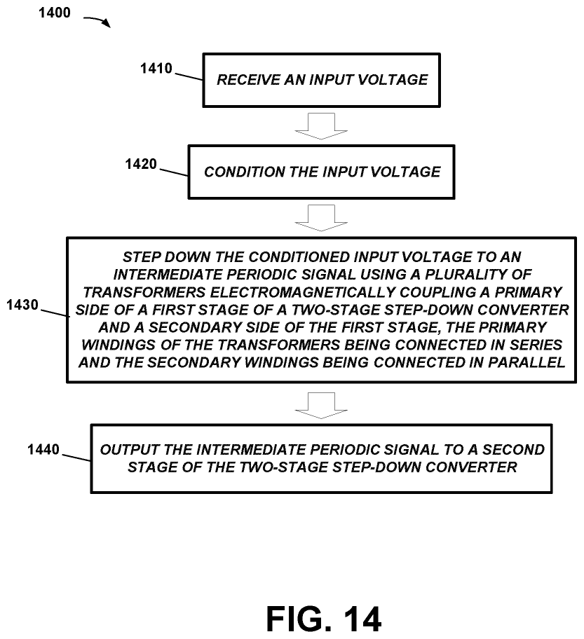

FIG. 14 illustrates a method 1400 for use in powering an electronic component in a computing device, such as the electrical load 115 of the computing device shown in FIG. 1. Referring collectively now to FIGS. 1-2 and 14, the method 1400 begins by receiving (at 1410) an input voltage, such as the input signal 130. The method 1400 then conditions (at 1420) the input voltage. The conditioned input voltage is then stepped down (at 1430) to an intermediate periodic signal, such as the signal 140, using a plurality of transformers 200 electromagnetically coupling a primary side 205 of a first stage 120 of a two-stage step-down converter 105 and a secondary side 210 of the first stage 120. The primary windings 215 of the transformers 200 are connected in series and the secondary windings 220 are connected in parallel as shown in any one of FIGS. 5, 7, 9, and 11. The method 1400 then outputs (at 1440) the intermediate periodic signal 140 to a second stage 125 of the two-stage step-down converter 105.

This concludes the detailed description. The particular examples disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular examples disclosed above may be altered or modified and all such variations are considered within the scope and spirit of the invention. Accordingly, the protection sought herein is as set forth in the claims below.

What is claimed:

1. A two-stage step-down converter, comprising:
a first stage to step down an input voltage down to an intermediate periodic signal, the first stage including:
a primary side including a first plurality of switches to condition the input voltage;
a secondary side including a second plurality of switches to output the intermediate periodic signal; and
a plurality of transformers electromagnetically coupling the primary side and the secondary side to step down the input voltage to the intermediate periodic signal, the primary windings of the transformers being connected in series and the secondary windings being connected in parallel; and
a second stage operatively connected to the first stage.

2. The two-stage step-down converter of claim 1, wherein the plurality of transformers step down the input voltage to the first stage by an amount proportional to a number of the plurality of transformers.

3. The two-stage step-down converter of claim 1, wherein:
the input voltage is a 48V signal; and
the intermediate periodic signal has a 12V amplitude with up to a 90% duty cycle pulse.

4. The two-stage step-down converter of claim 1, wherein:
the input voltage is a 48V signal; and
the intermediate periodic signal has a 24V amplitude with up to a 90% duty cycle pulse.

5. The two-stage step-down converter of claim 1, wherein:
the input voltage is a 48V signal; and
the intermediate periodic signal has a 12V amplitude with up to a 50% duty cycle pulse.

6. The two-stage step-down converter of claim 1, wherein each of the plurality of transformers occupies a footprint no larger than 10 mm wide×10 mm long and is no taller than 10 mm high.

7. The two-stage step-down converter of claim 1, wherein the physical size of each of the plurality of transformers is selected based on the switching frequency.

8. The two-stage step-down converter of claim 1, wherein the intermediate periodic signal is a square wave signal.

9. The two-stage step-down converter of claim 1, wherein the second stage includes circuitry to convert the intermediate square-wave signal into a regulated DC output signal having a low voltage.

10. The two-stage step-down converter of claim 1, further comprising a switching circuit to control the first plurality of switches and the second plurality of switches.

11. The two-stage step-down converter of claim 1, wherein each of the plurality of transformers is a 1:1 transformer.

12. The two-stage step-down converter of claim 1, wherein the second stage comprises a low pass filter.

13. The two-stage step-down converter of claim 1, wherein the second stage comprises a multi-phase switching buck regulator.

14. A method for use in powering an electronic component in a computing device, the method comprising:
receiving an input voltage;
conditioning the input voltage;
stepping down the conditioned input voltage to an intermediate periodic signal using a plurality of transformers electromagnetically coupling a primary side of a first stage of a two-stage step-down converter and a secondary side of the first stage, the primary windings of the transformers being connected in series and the secondary windings being connected in parallel; and
outputting the intermediate periodic signal to a second stage of the two-stage step-down converter.

15. The method of claim 14, wherein the plurality of transformers steps down the input voltage to the first stage by an amount proportional to a number of the plurality of transformers.

16. The method of claim 14, wherein:
the input voltage is a 48V signal; and
the intermediate periodic signal has a 14V amplitude with up to a 90% duty cycle pulse.

17. The method of claim 14, wherein:
the input voltage is a 48V signal; and
the intermediate periodic signal has a 24V amplitude with up to a 90% duty cycle pulse.

18. The method of claim 14, wherein:
the input voltage is a 48V signal; and
the intermediate periodic signal has a 14V amplitude with up to a 50% duty cycle pulse.

19. A computing device, comprising:
a two-stage step-down converter to convert an input voltage to an output voltage less than the input voltage, the two-stage step-down converter including a plurality of transformers electromagnetically coupling a primary side of a first stage of the two-stage step-down converter and a secondary side of the two-stage step-down converter to step down the input voltage to an intermediate periodic signal, the primary windings of the transformers being connected in series and the secondary windings being connected in parallel;
a switch controller to control a first plurality of switches in the primary side and a second plurality of switches in the secondary side; and
an electrical load to consume an output signal of the two-stage step-down converter at the output voltage.

20. The computing device of claim 19, wherein the plurality of transformers steps down the input voltage to the first stage by an amount proportional to a number of the plurality of transformers.

21. The computing device of claim 19, wherein each of the plurality of transformers occupies a footprint no larger than 10 mm wide×10 mm long and is no taller than 10 mm high.
